(19) United States
(12) Patent Application Publication
(10) Pub. No.: US 2007/0011854 A1
(43) Pub. Date: Jan. 18, 2007

(54) Modular set of cladding elements

(76) Inventor: Angelo Pessolano, Viggiano (IT)

Correspondence Address: MODIANO & ASSOCIATI, Via Meravigli, 16, Milan, 20123, IT

(21) Appl. No.: 11/474,275

(22) Filed: Jun. 26, 2006

(30) Foreign Application Priority Data
Jul. 12, 2005 (IT) BO2005A000461

(51) Int. Cl. B23P 23/04

(52) U.S. Cl. 29/33 R

(57) ABSTRACT

A modular set of cladding elements, comprising a plurality of substantially square elements and a plurality of substantially rectangular elements, each square element and each rectangular element having sides whose length is substantially equal to a multiple of the length of the sides of the smallest square element that belongs to the set.

### BACKGROUND OF THE INVENTION

Cladding elements are currently provided in practice with any kind of material, although ceramic materials and extraction materials constitute most of production.

Depending on the type of process and fitting provided, cladding elements have preset shapes and sizes.

The standard practice is to produce elements of standard size, with which walls, floors or other surfaces are clad.

Depending on the material of which the cladding elements are made, the size standards are different, and even within a same sector (for example wood or ceramics) there are no definite size rules adopted by all manufacturers.

Depending on the size of the surface to be clad, the elements may be large or small in order to facilitate the fitting operations for the tiler; for small surfaces, the possibility to use small elements ensures that the amount of cuts to be made in order to adapt these elements to the installation surface is minimized; on the contrary, for large surfaces it is convenient to have available large elements, which minimize the number of elements required for complete cladding.

Regardless of the format of the cladding elements to be provided, the cutting of the material, starting from large slabs, always entails a certain amount of waste due to the irregularity of said slabs; however, this occurs only in the case of the wood and stone sector but not in the case of the ceramics sector.

The cost of each individual element must therefore take into account also this waste: some formats, therefore, can reach high costs.

For example, a large element certainly entails considerable waste of material starting from the slab and therefore the cost of the individual element is high (however, fitting costs might be lower).

It should be noted that the lack of size rules in the manufacture of the various products that compose the finishing elements used in the erection of buildings entails a higher production cost of said elements and limits their mutual combination.

In practice, the limitation that cannot be overcome is linked to the lack of interchangeability and combinability among the various elements.

### SUMMARY OF THE INVENTION

The aim of the present invention is to obviate the above-mentioned drawbacks and meet the mentioned requirements, by providing a modular set of cladding elements that provides more efficient production in the various product sectors and facilitates the interchangeability and combinability of the various manufactured elements both within the same product sector and among different related sectors.

Within this aim, an object of the present invention is to provide a set of cladding elements that is simple to fit because it can be adapted substantially to surfaces of several shapes and sizes.

Another object of the present invention is to provide a modular set of cladding elements that allows to minimize the waste of material during the operations for cutting and manufacturing each individual element.

Another object of the present invention is to provide a modular set that is simple, relatively easy to provide in practice, safe in use, effective in operation, and has a relatively low cost.

This aim and these and other objects that will become better apparent hereinafter are achieved by the present modular set of cladding elements, characterized in that it comprises a plurality of substantially square elements and a plurality of substantially rectangular elements, each of said square elements and each of said rectangular elements having sides whose length is substantially equal to a multiple of the length of the sides of the smallest square element that belongs to said set.

### BRIEF DESCRIPTION OF THE DRAWINGS

Further characteristics and advantages of the invention will become better apparent from the following detailed description of a preferred but not exclusive embodiment of a modular set of cladding elements, illustrated by way of non-limiting example in the accompanying drawings, wherein:

FIG. 1 is a schematic view of a plurality of elements of a set according to the invention, arranged side by side;

FIG. 2 is a schematic view of a plurality of elements of a set according to the invention arranged side by side by way of example according to a possible arrangement for a cladding;

FIG. 3 is a top view of an apparatus adapted to provide a set of elements according to the invention.

### DESCRIPTION OF THE PREFERRED EMBODIMENTS

With reference to the figures, the reference numeral 1 generally designates a modular set of cladding elements.

The set comprises a plurality of substantially square elements and a plurality of substantially rectangular elements.

Each square element and each rectangular element has sides whose length is substantially equal to a multiple of the length of the sides of the smallest square element that belongs to the set 1: such smallest element is referenced hereinafter as first square element 2.

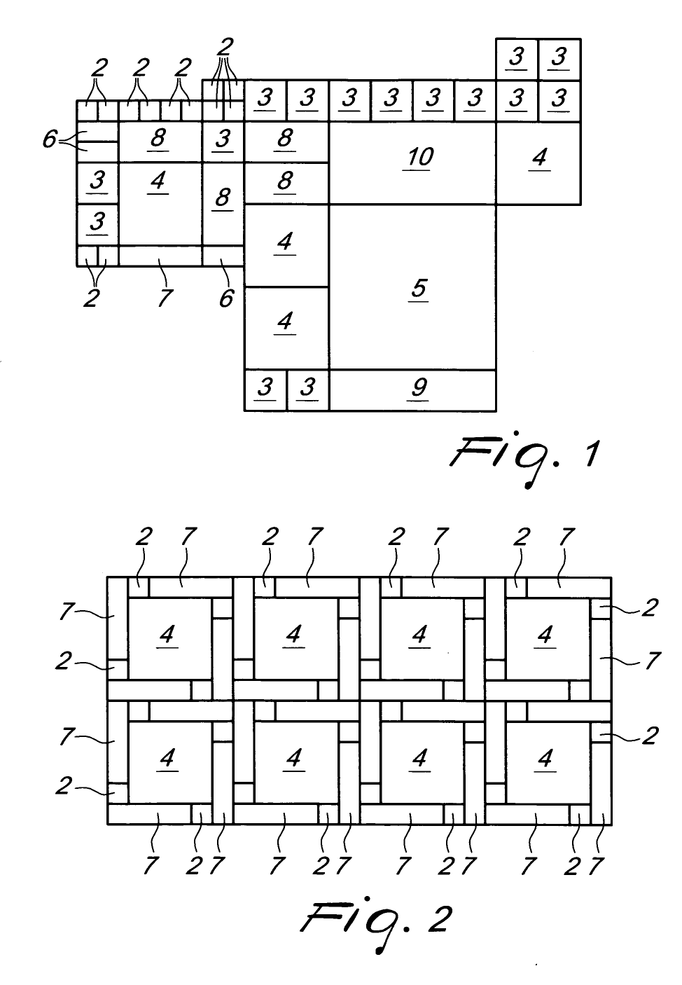

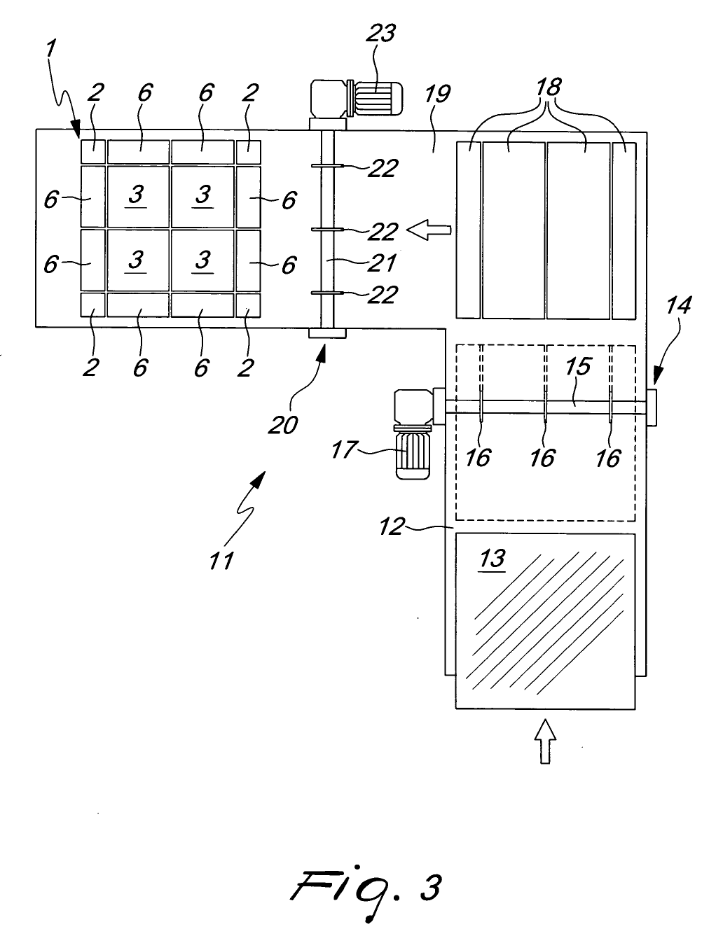

The plurality of square elements is constituted, in a preferred but not exclusive embodiment shown in FIG. 1, by four elements.

The smallest element, which has already been defined, is the first element 2; there is a second directly larger element 3, whose sides are substantially twice as long as the sides of the first element 2: the surface of the second element 3 is equal to four times the surface of the first element 2 (FIG. 1 shows that with four first elements 2 it is possible to cover the area occupied by the second element 3). The set 1 also comprises a third square element 4, which is larger than the preceding ones and whose sides are substantially four times as long as the sides of the first element 2 (the surface of the third element 4 is equal to four times the surface of the second element 3 and sixteen times the surface of the first element 2).

Among the square elements, the largest one (always only with reference to the example shown in FIG. 1 and without any constructive limitation for solutions of larger sizes) is the fourth square element 5, whose sides are substantially eight times as long as the sides of the first element 2 (the surface of the fourth element 5 is equal to four times the surface of the third element 4, sixteen times the surface of the second element 3, and sixty-four times the surface of the first element 2).

The plurality of rectangular elements is constituted, in a preferred but not exclusive embodiment shown in FIG. 1, by four elements.

A first rectangular element 6 has a short side that is substantially as long as the sides of the first square element 2 and a long side that is substantially twice as long as the sides of the first square element 2: in practice, the first rectangular element 6 has the same surface as two of the first square elements 2 arranged side by side.

A second rectangular element 7 has a short side that is substantially as long as the sides of the first square element and a long side that is substantially four times as long as the sides of the first square element 2: in practice, the second rectangular element 7 has the same surface as four of the first square elements 2 arranged side by side.

A third rectangular element 8 has a short side that is substantially twice as long as the sides of the first square element 2 and a long side that is substantially four times as long as the sides of the first square element 2: in practice, the third rectangular element 8 has the same surface as eight of the first square elements 2 arranged side by side, four by four, along two superimposed lines.

A fourth rectangular element 9 has a short side that is substantially twice as long as the sides of the first square element 2 and a long side that is substantially eight times as long as the sides of the first square element 2: in practice, the third rectangular element 8 has the same surface as sixteen of the first square elements 2 arranged side by side, eight by eight, along two superimposed lines.

A fifth rectangular element 10 (the largest one) has a short side that is substantially four times as long as the sides of the first square element 2 and a long side that is substantially eight times as long as the sides of the first square element 2: in practice, the third rectangular element 8 has the same surface as thirty-two of the first square elements 2 arranged side by side, eight by eight, along four superimposed lines.

In practical execution, it can be seen that the length of the sides of the elements is a multiple of the length of the sides of the first square element minus a factor that corresponds to the space between one element and the contiguous one during fitting: this is necessary because during fitting it is practically impossible to match up perfectly the sides of two contiguous elements (due to small size defects) and therefore it is convenient to leave a space (known in the jargon as gap) intended to minimize the visual impact of size irregularities.

The elements that constitute the set 1 are preferably made of stone-like material: it might be marble, granite, lava rock, or any other material suitable for construction work.

Any alternative embodiments for the elements that constitute the set 1 of the homogeneous type are made of material substantially of the type of ceramics or wood (solid, laminated, multilayer or even chipboard or plywood) or of a material of the polymeric or optionally metallic type.

One set 1 can also comprise heterogeneous elements and therefore combine with elements made of stone-like material other elements made of wood or polymer or ceramics or metal depending on constructive requirements.

At the same time, each individual element also can be made of composite material (obtained for example by combining various layers of at least two of the cited materials).

In order to provide the elements that constitute the set 1 (in particular when they are made of stone-like or wood-like material), it is convenient to use a device that comprises a conveyor belt 12 for conveying slabs 13 of raw material.

The belt 12 carries each slab 13 to a cutting station 14, which is provided with a rotating shaft 15 on which a plurality of blades 16 is fitted; said blades are mutually spaced with a pitch equal to the width of the various elements being produced.

The shaft 15 is turned by a respective motor 17.

Each slab 13, after passing through the cutting station 14, is constituted by a plurality of substantially rectangular strips 18.

Downstream of the cutting station 14 there is a second conveyor belt 19, which is substantially perpendicular to the first conveyor belt 12, designed to convey the strips 18 toward a second cutting station 20, which is also provided with a respective rotating shaft 21, on which a plurality of blades 22 is fitted: said blades are mutually spaced with a pitch equal to the length of the various elements being produced. The second rotating shaft 21 is actuated by a respective motor 23.

Downstream of the second cutting station 20, the initial slab 13 is cut according to the dimensions of the elements that constitute the set 1 according to the invention.

The operation of the invention is as follows: the elements that constitute the set 1 can in fact be used to clad practically any surface without having to provide cuts on the elements but simply by choosing the most convenient arrangement depending on the dimensions of the surface to be clad.

Positively, the set 1 allows to combine elements made of different materials, with the advantage of utilizing the material that is most adapted for a specific region of the surface to be clad (requirements linked to the nature of the surface or to the presence of utilities that require particular thermal or electrical insulation characteristics).

It has thus been shown that the invention achieves the intended aim and objects.

The invention thus conceived is susceptible of numerous modifications and variations, all of which are within the scope of the appended claims.

All the details may further be replaced with other technically equivalent ones.

In the exemplary embodiments shown, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

In practice, the materials used, as well as the contingent shapes and dimensions, may be any according to requirements without thereby abandoning the scope of the protection of the appended claims.

The disclosures in Italian Patent Application No. B02005A000461 from which this application claims priority are incorporated herein by reference.

What is claimed is:

1. A modular set of cladding elements, comprising a plurality of substantially square elements and a plurality of substantially rectangular elements, each of said square elements and each of said rectangular elements having sides whose length is substantially equal to a multiple of the length of sides of a smallest square element that belongs to said set.

2. The set of claim 1, wherein said square elements are at least three: a first square element having very short sides, a second square element having sides that are substantially twice as long as those of the first element, and a third element having sides that are substantially four times as long as those of the first element.

3. The set of claim 2, wherein said rectangular elements are at least three: a first rectangular element, whose short side is substantially as long as the sides of said first square element and whose long side is substantially twice as long as the sides of said first element; a second element, whose short side is substantially as long as the sides of said first element and whose long side is substantially four times as long as the sides of said first element; and a third element, whose short side is substantially twice as long as the sides of said first element and whose long side is substantially four times as long as the sides of said first element.

4. The set of claim 1, wherein the length of the sides of said elements is a multiple of the length of the sides of the first square element minus a factor that corresponds to a space between one element and the contiguous one upon fitting.

5. The set of claim 1, wherein said elements are made of stone-like material.

6. The set of claim 1, wherein said elements are made of a material substantially of the ceramic type, such as for example stoneware, porcelain stoneware, agglomerates based on marbles and resins, terracotta, et cetera.

7. The set of claim 1, wherein said elements are made of a material substantially of the wood type.

8. The set of claim 1, wherein said elements are made of a material substantially of the polymeric type.

9. The set of claim 1, wherein said elements are made of metallic material.

10. An apparatus for providing a modular set of cladding elements according to claim 1, comprising a conveyor belt for conveying slabs of raw material, a station for cutting said slabs, which is provided with a rotating shaft on which a plurality of blades is fitted, said blades being mutually spaced with a pitch equal to a width of the various elements being provided.

11. The apparatus of claim 10, further comprising a second conveyor belt, which is substantially perpendicular to the first conveyor belt, and a second station for cutting said slabs, which is provided with a second rotating shaft, on which a plurality of blades is fitted, said blades being mutually spaced with a pitch equal to a length of the various elements being provided.
